(19) United States
(12) Patent Application Publication
(10) Pub. No.: US 2004/0088157 A1
(43) Pub. Date: May 6, 2004

(54) Method for characterizing/classifying a document

(75) Inventors: Lawrence E. Lach, Chicago, IL (US); Thomas Michael Tirpak, Glenview, IL (US); Maria B. Thompson, Hoffman Estates, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/283,652

(22) Filed: Oct. 30, 2002

(51) Int. Cl. G06F 17/27

(52) U.S. Cl. 704/9

(57) ABSTRACT

Textual documents are readily classified and/or characterized with respect to other documents by determining a corresponding level of semantic distance between such documents. For example, particular parts of speech are identified, and those words in the documents that correspond to such parts of speech are identified and extracted. Matches of such wording between the documents permit identification of a given corresponding semantic distance value. When no matches occur (or when otherwise desired), synonyms for such words can be used to ascertain more distant semantic relationships. The process can be repeated in an iterative fashion using ever-deepening tiers of synonyms.

### TECHNICAL FIELD

This invention relates generally to semantic analysis of documents containing text.

### BACKGROUND

Text comprised of words that are linked and associated with one another in accord with corresponding rules of grammar to convey information and thought comprises a well-understood area of human endeavor. It is also well-understood that such text can be digitally stored using, for example, the relatively ubiquitous American Standard Code for Information Interchange (ASCII) for later retrieval and review. Literally hundreds of millions of documents are presently stored and made available in such a manner. As one simple example, the United States Patent and Trademark Office makes the text of millions of issued U.S. patents and published patent applications available via the Internet and other mechanisms (such as compact disc read-only memory). Users virtually anywhere in the world can access such digitally stored documents to support, for example, various inquiries and research activities.

The nearly universal accessibility of such vast archives, however, is not a panacea in and of itself. Using information of value in such a circumstance can prove to be a challenging and error-prone process. Some prior art approaches permit the text (either the full text of one or more documents or only selected portions thereof) to be compared against one or more words of interest (such as so-called keywords) to thereby identify documents that contain such words of interest and to thereby possibly identify documents of interest. Some improvements upon this approach permit multiple words to be combined (using Boolean logic or some functional counterpart) to hopefully aid in identifying documents of potential relevance. While useful in some applications, such approaches are not always necessarily helpful.

For example, on occasion, an individual may be interested in ascertaining how a given document (or group of documents) compares to one or more other documents (or groups of documents) with respect to content similarity (as may be useful when seeking to classify a given document as belonging or according to one specific group of documents amongst a large number of such groups). As one illustration, someone may be interested in comparing the substantive content of a given issued patent against the patents that are owned by a plurality of companies that together constitute a given industry. A typical prior art approach might necessitate an expert review of the given issued patent to yield one or more keywords and/or other search expression(s). This resultant deliverable could then be compared against the textual contents of all of the patents of all of the companies to attempt to identify those patents that match the search criteria. That resulting pool of documents could then be reviewed, again by a human expert, to ascertain the degree to which any contextual nexus indeed exists as between the original given issued patent and the other patents. Those results could then be used, for example, to attempt to more generally characterize the contextual relationship between the given issued patent and the companies being studied.

A process such as the one just described tends to be highly subjective and greatly dependent upon the human expert or experts who facilitate the task. Furthermore, the results themselves tend to be relatively amorphous and do not submit readily to characterization metrics or subsequent study or review. The results also tend to be relatively unique to the given study itself and do not lend themselves conveniently and intrinsically to subsequent studies involving yet other documents. As a result, to a great extent, document review to support document characterization tends to be relatively time consuming, i.e., requiring significant time and attention of one or more domain experts. In addition, the relatively subjective results of the process often tend to be relatively unique to a given set of circumstances and search conditions and further often do not lend themselves to metricized or other quantitative characterization, cataloging, storage, or review. These deficiencies in the current practice also tend to increase the overall cost of the effort as well.

### BRIEF DESCRIPTION OF THE DRAWINGS

The above needs are at least partially met through provision of a method for characterizing/classifying a document as described in the following detailed description, particularly when studied in conjunction with the drawings, wherein:

FIG. 1 comprises a block diagram as configured in accordance with an embodiment of the invention;

FIG. 2 comprises a flow diagram as configured in accordance with various embodiments of the invention;

FIG. 3 comprises a detailed flow diagram as configured in accordance with an embodiment of the invention; and

FIG. 4 comprises a detailed flow diagram as configured in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, one selects at least one category of speech of interest for a given body of text. The process then seeks to identify at least one instance of that category of speech as occurs in the given body of text to thereby provide identifying text. One then identifies, for each of one or more of a plurality of document groups (which document groups may contain one or more documents), those textual documents (if any) that are within a first predetermined semantic distance of the body of text as a function of the identifying text. When no such textual documents within the first predetermined semantic distance exist, the process then identifies each textual document (if any) that is within a second predetermined semantic distance of at least a first expression that comprises a synonym of the identifying text. In this way, a given document can be characterized as being within a given semantic distance of one or more other documents (or groups of documents).

Such a measure can be ascertained in a relatively automatic (and rapid) manner and further can serve as a relatively objective characterization metric.

Depending upon the specific embodiment, additional comparisons can be conducted to ascertain deeper levels of semantic distance. For example, synonyms of previously identified synonyms can be identified and used to characterize documents as being within a corresponding semantic distance as otherwise described above. In one embodiment, synonyms are provided as described for only the identified text (or for synonyms of the identified text or synonyms thereof) when ascertaining more distant semantic distances. In a preferred embodiment, synonyms are provided for both the identified text in the original body of text and for words that similarly match the category of speech in the plurality of documents groups.

The category of speech can be varied and selected as appropriate to a given application. For example, in a preferred embodiment, the category of speech will comprise at least one word that serves a predetermined purpose, such as serving a predetermined grammatical purpose (for example, by serving as a grammatical subject or predicate) or by serving a predetermined contextual purpose (for example, by representing a problem to be solved or the solution to a problem).

When characterizing a given document with respect to a plurality of document groups, with at least one of the document groups itself being comprised of a plurality of documents, the resultant semantic distance values can be further normalized or weighted to facilitate ease of comparison and characterization. For example, in one embodiment, the number of documents in a given document group that each contain a word or expression (or dependent synonym) that represents a corresponding match as described above can be divided by the total number of documents in that group to thereby represent a degree by which that document group correlates to that corresponding semantic distance for the original document. Such weighting will not necessarily result in a strictly linear outcome, but in general the more similar the set of documents, the larger the measured value.

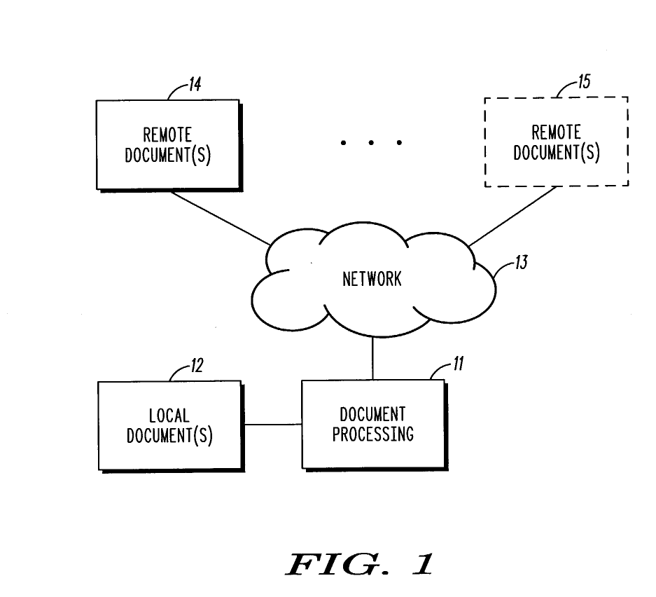

Referring now to FIG. 1, a document processing platform 11, such as a computer, contains part or all of a document to be compared and/or characterized. In a preferred embodiment, the entire document would be resident and available at this platform 11, but other configurations are possible and possibly preferable under certain operating conditions. For example, pre-processing results can be used by the platform 11 instead of the entire document, where the pre-processing results can represent, for example, a signature of the relevant contents of the document (as one example, previously selected text categories as previously extracted from an original document can be provided to the document processing platform 11 to permit further processing as described herein). Such pre-processing can be accomplished manually or through automatic means (using, for example, semantic review, analysis, and/or parsing software programs as are known in the art). If desired, this original document can be provided through provision of a local document storage platform 12, such as a local server that provides this functionality.

As noted earlier, pursuant to these various embodiments, one or more documents can be processed via the document processing platform 11 to characterize such document(s) with respect to one or more other documents or groups of documents. Such other documents can be obtained from a variety of sources. For example, these other documents can be retained in the local document platform 12 (either temporarily or permanently). In the alternative, or in combination therewith, such documents can be obtained from one or more remote document platforms 14 and 15 via an appropriate communications link such as, for example, a network 13 like the Internet or a local area network for a given enterprise.

As one simple example, a selected document can be a given issued United States patent. A first group of documents can be identified by searching a public database to locate all issued patents for a first given company (in this example, “Company X”) and a second group of documents can be identified by searching that same public database to locate all issued patents for a second given company (in this example, “Company Y”). (Such searches can be conducted through the document processing platform 11 and the network 13 if desired or through use of some other appropriate and convenient platform as well understood in the art.) The text, in digital and machine-readable form, is then obtained and provided to the document processing platform 11. For example, the corresponding issued patent numbers for these two companies can be used to access the United States Patent and Trademark Office website and to obtain these documents in such a format. In this way, a first grouping of documents (comprising issued U.S. patents for Company X) and a second grouping of documents (comprising issued U.S. patents for Company Y) are identified and provided for use as described herein.

Such platforms, networks, document and data formats, databases, and searching functionality and capability are all well known and understood in the art. Therefore, for the sake of brevity and the preservation of focus, no further elaboration will be provided here regarding such elements. It should be understood, however, that these teachings are not limited to any particular selection of components or configuration thereof, nor to any particular data format or document identification, storage, or retrieval mechanism. Instead, these teachings are generally applicable to a wide variety of such elements without any particular restriction or encumbrance. Further, there are no particular limitations with respect to the kinds of textual documents, language, subject matter genre, or predetermined purpose or category of speech to which these teachings may be beneficially applied.

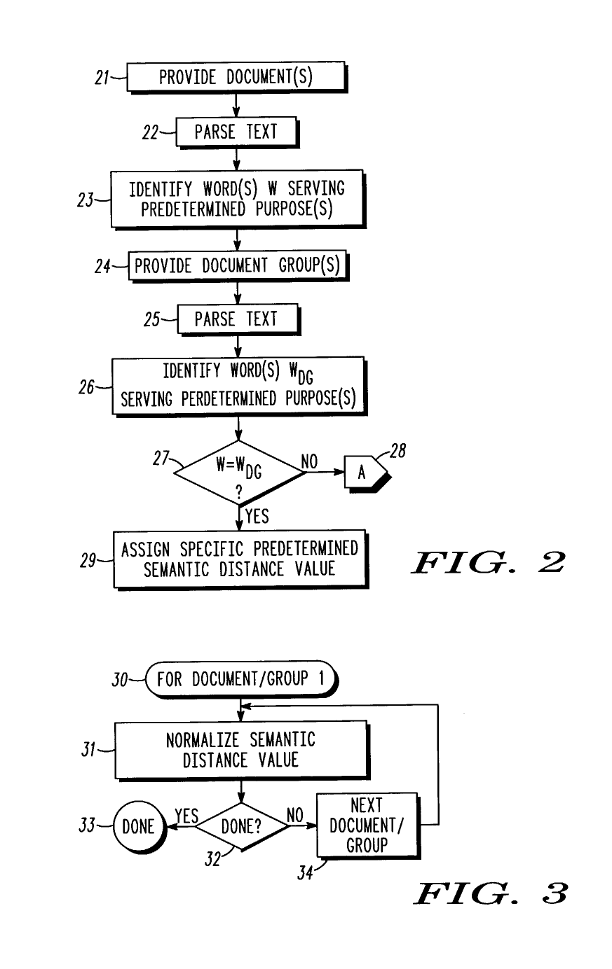

Referring now to FIG. 2, one embodiment for an overall process begins with the provision 21 of one or more documents to be characterized and/or classified. For the sake of clarity, this example presumes only a single document. (Pursuant to one embodiment, when characterizing multiple documents, each such document can be processed and characterized in seriatim fashion as otherwise now described.) By then parsing 22 the document text, a word or words that serve a predetermined purpose are identified 23 and extracted. The predetermined purpose can be any of a wide variety of purposes. The user would select the particular predetermined purpose to suit the needs of a given application.

To illustrate, the predetermined purpose could be a predetermined grammatical purpose (such as serving as a grammatical subject or predicate in a sentence) and/or a predetermined contextual purpose (such as serving as a representation of a problem to be solved or a representation of a solution to a problem). Various grammatical and/or semantic analysis software-based tools exist to facilitate such parsing, and hence further discussion and explanation of such tools and engines need not be provided here, suffice to note that the particular mechanism and process selected by a user for a given application should be reasonably commensurate in functionality with the needs of the given desired process.

The words and/or expressions as so parsed and extracted from the document will be used, as described below in more detail, to compare against the contents of one or more other documents to ascertain a degree or distance of semantic similarity or difference therebetween. These words can be further pre-processed if desired to expand or contract the ease or exactness by which such comparisons shall be made. For example, when an extracted word comprises a singular noun, such as “engine,” plural forms (such as “engines”) can also be automatically formed and added to the list of characterizing words/expressions for the document. As another example, when an extracted word comprises a verb of a given tense (such as “heat”), other verb tenses (such as “heats” or “heated”) can also be similarly automatically formed and added to the list of characterizing words/expressions for the document. As yet another example, the root of the extract word can be automatically ascertained (for example, “equip” comprises a root expression for the word “equipment”) and utilized to either generate other words with the same root (such as “equipped” or “equips” for the root “equip”) or utilized in combination with an appropriate universal character or suffix/prefix (such as “equip*” where the asterisk serves to represent one or more additional letters) to thereby represent various words sharing the same root. In general, such pre-processing serves to expand the number of words that can be potentially successfully matched to words that serve the same predetermined purpose in the comparison documents as described below.

The process then provides 24 one or more other documents, and in a preferred embodiment, a plurality of document groups wherein each of the document groups comprises a plurality of constituent documents. In this embodiment, such documents can include graphic images, but such images are not processed or compared with the contents of the original document. If desired, of course, such graphic images could be processed in a way that would permit such comparison and subsequent characterization, and these teachings should not be viewed as excluding such an approach.

As noted earlier, the text of these documents is preferably in machine-readable form. When such is not the case, additional processing, such as alphanumeric character recognition in accordance with well understood prior art technique can be utilized to convert the text into machine-readable form. The text comprising these documents is then parsed 25 to permit the identification of 26 words and/or expressions that serve the already identified predetermined purpose and/or comprise the already identified category of speech. For example, if the predetermined criteria as used to parse the original document comprised grammatical subjects, then identical criteria would be used to parse the text of these additional documents to identify the grammatical subjects contained therein. Again, known processes and platforms exist to permit the identification of such criteria and the subsequent automatic review and parsing of a body of text in this manner.

The parsed contents of the original document and the document groups are then compared 27 to identify matches. For example, and to continue the immediate example, if the predetermined criteria comprised grammatical subjects, and one of the grammatical subjects in the original document comprises the word “perovskites” (as extracted, for example, from the sentence, “Perovskites have many useful properties in this context.”) then this word would be compared against the extracted grammatical subjects of the various other documents. For example, if one of the other documents includes the sentence, “Perovskites frequently contain rare earth elements,” then the subject of this sentence, “perovskites,” would match this word as found as a subject in a sentence in the original document. As a result, the comparison 27 would identify a match in this instance and a corresponding specific predetermined semantic distance value could be assigned 27 accordingly. (It should be noted that the mere appearance of the word “perovskites,” other than as a grammatical subject, would not have led to a similar result. For example, if the word “perovskites” had appeared other than as a grammatical subject, it would not have been parsed, identified, and thereby made available for this comparison.)

When an exact match occurs at this level of comparison and analysis, a semantic distance of “0” could be assigned to indicate a degree of semantic identity as between the two documents. The particulars of a given semantic distance value can be determined and/or varied in different ways to suit various needs and applications. For example, in one embodiment, any match between two documents with respect to the predetermined characterizing criteria could be used to assign a given semantic distance value to characterize the one document with respect to the other.

In another embodiment, and referring momentarily to FIG. 3, for a given group of documents 30 the semantic distance value can be normalized 31 or weighted to facilitate interpretation of the results. For example, pursuant to one approach, such a match can be normalized with respect to a single document by dividing the number of successful matches by the number of candidate matching opportunities. To illustrate this with a simple example, if the comparison criteria comprised a grammatical predicate and if the given document included 15 grammatical predicates, and if that document had 10 exact matches with the predicate content of the original document, then 10/15 could be multiplied with the semantic distance value to normalize the resultant value (when using such an approach, of course, a value such as zero should not ordinarily be used for the initial semantic distance value).

Pursuant to another approach, such matches could be normalized with respect to a plurality of documents to facilitate results comparisons with a plurality of document groups. To illustrate this with a simple example, if a given document grouping had 10 documents, and if 5 of those documents produced an exact match as described above, the number of matching documents could be divided by the total number of candidate documents (i.e., 5/10) to produce a value that could again be multiplied with the initial semantic distance value to yield a normalized semantic distance value for the document group as a whole.

Other approaches and techniques could be utilized as desired to normalize the semantic distance values, either with respect to a single document, a group of documents, or a plurality of a group of documents and make interpretation of the resultant values at least somewhat less dependent upon any unique circumstances related to the documents and/or groups of documents. In any event, and with continued reference to FIG. 3, once the document or group of documents has been normalized 31, the process can then determine whether the normalization task is done 32. If not yet done, the process selects the next document or group 34 and the normalization process repeats. Otherwise, the process concludes 33.

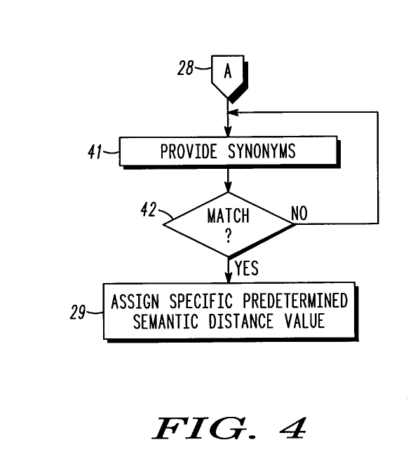

Referring again to FIG. 2, in many instances it can be expected that the comparison step 27 will not yield an exact match. (The likelihood of an exact match will vary not only with subject matter differences between the documents but also with the comparison criteria itself. For example, when the comparison criteria comprises grammatical subjects, a number of exact matches may be anticipated as between many documents because so many relatively common words are used in ordinary written discourse as grammatical subjects regardless of the subject matter. Other criteria, however (such as well defined contextual criteria), may well yield fewer matches for any given set of documents because of a reduced likelihood of contextual similarity.) When no exact match at this level of inquiry occurs, the process continues 28, in a preferred embodiment, as illustrated at FIG. 4.

Pursuant to this approach, when no match occurs with respect to the extracted words that correlate to the parsed text content, one or more synonyms are identified 41 for one or more of the extracted words (numerous prior art platforms exist to permit and facilitate the identification of synonyms for a given word or expression). For example, if the original document included the word “orange,” and no match occurred, synonyms such as “citrus” or “fruit” can be provided 41. The matching process 42 as described above is then again undertaken to determine if any matches can now be found. When such a match does occur, a corresponding semantic distance value can then be assigned 29 to characterize the identification result (for example, if a value of zero serves to identify an exact match between relevant words, a value of one can similarly serve to identify that a match occurs when using a first level of synonym(s)).

There are various optional approaches to consider when implementing this basic technique. For example, pursuant to one embodiment, synonyms are only identified for words in the original document and not for words in the other documents. Pursuant to this approach, if the original document contains the word “orange” and one of the other documents contains the word “pear,” and if selected synonyms for “orange” comprise “citrus” and “fruit” as noted above, then a match will again fail to occur when matching these words at this level of inquiry. Pursuant to another embodiment, however, synonyms can also be identified for the words in the other documents as well as for the words in the original document. Pursuant to such an approach, and presuming for purposes of illustration that the word “fruit” would be a selected synonym for both “orange” and “pear,” a match would occur and a corresponding semantic distance value could be assigned accordingly. If desired, and pursuant to yet another embodiment, synonyms could be developed for the other documents only and not for the original document words.

As suggested by one of the illustrations just offered, a match will not necessarily result when using synonyms of the relevant words for one or more of the documents. When this happens, and referring still to FIG. 4, the process continues by determining additional words to consider. In particular, synonyms for the previously determined synonyms are provided 41 and matches 42 are again sought. To illustrate, if the original word of interest was “orange” and the first synonym was “fruit,” then a second round of synonyms (based on the word “fruit”) could generate a number of specific fruit examples, including “pear.” This synonym for the word “fruit” would then exactly match the word “pear” as appears in the other document as set forth in the example above (presuming, of course, that only synonyms for the original document are being offered in this illustration). A corresponding semantic distance value could then be assigned 29. For example, a value of “2” could be used to denote a semantic proximity evidenced by a match that occurs at a second incremental tier of synonyms.

The above process could be continued, if desired, with additional incremental tiers of synonym identification and matching to identify ever more distant semantic similarities between documents. For example, the synonym “fruit” as noted above can yield the synonym “food,” which in turn can yield the synonyms “edibles” and “bread,” which in turn can lead to the synonyms “nourishment” and “meals,” and so forth.

So configured, a semantic distance between two or more documents can be ascertained by determining the number of synonym tiers that must be considered to establish a match between such documents. The fewer the number of tiers, in general, the closer the semantic identity of the documents. By focusing the point of matching inquiry about specific categories of speech and/or words or expressions that serve a particular identifiable purpose, considerable subject matter relevance can be assured with respect to the meaning and utility of the resultant semantic distance value. Furthermore, the processes described above are readily subject to numerous alterations and modifications to aid in effecting a higher degree of focus and/or effective filtering to suit the needs of a given application. Because the entire process is readily automated through the use of appropriate software and programmable platforms, the characterization process can be effected relatively quickly even for a large number of documents and/or lengthy documents. It should be noted in this regard that these processes also scale in a favorable fashion. In particular, computational complexity tends to increase only substantially linearly as the number of documents to be compared increase.

One potential embodiment of the process suggests that words as extracted from a given set of documents be retained as an effective signature for the corresponding document or documents (representing, for example, the problems or solutions identified within a document). For example, a portfolio of patents for a given company can be reviewed with respect to a comparison criteria such as problem identification as described above. Those results can then be retained and used to support subsequent characterization exercises with future documents. To continue this illustration, patents as they issue to a given company can be readily compared against these existing results to ascertain a resultant semantic distance between the issuing patents and the portfolio of the given company. Therefore, by retaining such document signatures for future use, necessary processing time to effect characterization of a given document can be reduced even further.

These embodiments offer many advantages and benefits as already noted. In addition, the process tends to be relatively objective and yields repeatable results. Furthermore, such benefits can be expected even when classifying or characterizing a new document among existing sets of documents where the contents of the sets of documents are relatively inhomogeneous and where no easily identifiable (or relevant) rules exist for membership in any given set.

Those skilled in the art will recognize that a wide variety of modifications, alterations, and combinations can be made with respect to the above described embodiments without departing from the spirit and scope of the invention. For example, one may wish to explore synonym formation and matching even when exact matches have been identified for a given pair of documents to further enrich the overall resultant semantic distance value determination process. As another example, one may wish to apply these techniques to documents within an already identified grouping of documents to thereby determine a measure of the relative semantic homogeneity of the documents that comprise such a grouping. Such modifications, alterations, and combinations are to be viewed as being within the ambit of the inventive concept.

We claim:

1. A method for ascertaining a classification of a document comprising a body of text with respect to at least one document group, which at least one document grouping is comprised of at least one text-containing document, comprising:
parsing the body of text and identifying at least one word that serves a predetermined purpose;
determining a semantic distance between the document and each of the at least one document groups as a function, at least in part, of:
firstly comparing the at least one word with other words that serve the predetermined purpose in the at least one document group;
when the at least one word does not match any of the other words within a predetermined tolerance:
automatically providing at least one synonym for the at least one word;
automatically providing at least one synonym for at least some of the other words;
secondly comparing the at least one synonym for the at least one word with the at least one synonym for at least some of the other words;
classifying the document as a function, at least in part, of the semantic distance between the document and each of the at least one document groups.

2. The method of claim 1 wherein parsing the body of text and identifying at least one word that serves a predetermined purpose includes parsing the body of text and identifying at least one word that serves a predetermined grammatical purpose.

3. The method of claim 2 wherein parsing the body of text and identifying at least one word that serves a predetermined grammatical purpose includes parsing the body of text and identifying at least one word that serves a predetermined grammatical purpose as a grammatical subject.

4. The method of claim 2 wherein parsing the body of text and identifying at least one word that serves a predetermined grammatical purpose includes parsing the body of text and identifying at least one word that serves a predetermined grammatical purpose as a grammatical predicate.

5. The method of claim 1 wherein parsing the body of text and identifying at least one word that serves a predetermined purpose includes parsing the body of text and identifying at least one word that serves a predetermined contextual purpose.

6. The method of claim 5 wherein parsing the body of text and identifying at least one word that serves a predetermined contextual purpose includes parsing the body of text and identifying at least one word that serves a predetermined contextual purpose as a representation of a problem to be solved.

7. The method of claim 5 wherein parsing the body of text and identifying at least one word that serves a predetermined contextual purpose includes parsing the body of text and identifying at least one word that serves a predetermined contextual purpose as a representation of a solution to a problem.

8. The method of claim 1 wherein firstly comparing the at least one word with other words that serve the predetermined purpose in the at least one document group includes assigning a specific predetermined semantic distance value to a document group that includes one of the other words that matches the at least one word to within the predetermined tolerance.

9. The method of claim 8 wherein determining a semantic distance between the document and each of the at least one document groups further includes normalizing semantic distance values as are assigned to the document groups by dividing a number of documents that match within the predetermined tolerance within each document group by a total number of documents as are contained within each corresponding document group.

10. The method of claim 1 and further comprising, when the at least one synonym for the at least one word does not match any of the at least one synonym for at least some of the other words:
automatically providing at least one synonym for the at least one synonym for the at least one word;
automatically providing at least one synonym for the at least one synonym for the at least some of the other words;
thirdly comparing the at least one synonym for the at least one synonym for the at least one word with the at least one synonym for the at least one synonym for the at least some of the other words.

11. A method for ascertaining relative correspondence between a first text document and at least one document grouping, wherein each document grouping is comprised of at least one corresponding other text document, comprising:
parsing the body of text and identifying at least:
a first word that serves a first predetermined purpose; and
a second word that serves a second predetermined purpose;
determining a semantic distance between the first text document and each of the at least one document groupings as a function, at least in part, of:
firstly comparing the first word with other words that serve the first predetermined purpose in the at least one corresponding other text document;
when the first word does not match any of the other words within a predetermined tolerance:
automatically providing at least one first word synonym for the first word;
automatically providing at least one synonym for at least some of the other words that serve the first predetermined purpose;
secondly comparing the at least one first word synonym with the at least one synonym for at least some of the other words that serve the first predetermined purpose;
firstly comparing the second word with other words that serve the second predetermined purpose in the at least one corresponding other text document;
when the second word does not match any of the other words within a predetermined tolerance:
automatically providing at least one second word synonym for the second word;
automatically providing at least one synonym for at least some of the other words that serve the second predetermined purpose;
secondly comparing the at least one second word synonym with the at least one synonym for at least some of the other words that serve the second predetermined purpose;
ascertaining a relative correspondence between the first text document and each of the at least one document groupings as a function, at least in part, of the semantic distance between the first text document and each of the at least one document groupings.

12. The method of claim 11 wherein identifying at least a first word that serves a first predetermined purpose includes identifying at least a first word that serves a first grammatical purpose, and identifying at least a second word that serves a second predetermined purpose includes identifying at least a second word that serves a second grammatical purpose.

13. The method of claim 12 wherein identifying at least a first word that serves a first grammatical purpose includes identifying at least a first word that serves as a grammatical subject and identifying at least a second word that serves a second grammatical purpose includes identifying at least a second word that serves as a grammatical predicate.

14. The method of claim 11 wherein identifying at least a first word that serves a first predetermined purpose includes identifying at least a first word that serves a first contextual purpose, and identifying at least a second word that serves a second predetermined purpose includes identifying at least a second word that serves a second contextual purpose.

15. The method of claim 14 wherein identifying at least a first word that serves a first contextual purpose includes identifying at least a first word that serves as a problem statement and identifying at least a second word that serves a second contextual purpose includes identifying at least a second word that serves as a solution statement.

16. The method of claim 11 and further comprising:
when the at least one first word synonym does not match any of the at least one synonym for at least some of the other words that serve the first predetermined purpose within a predetermined tolerance:
automatically providing at least one synonym for the at least one first word synonym;
automatically providing at least one synonym for the at least one synonym for the at least some of the other words that serve the first predetermined purpose;
thirdly comparing the at least one synonym for the at least one first word synonym with the at least one synonym for the at least one synonym for the at least some of the other words that serve the first predetermined purpose;
when the at least one second word synonym does not match any of the at least one synonym for at least some of the other words that serve the second predetermined purpose within a predetermined tolerance:
automatically providing at least one synonym for the at least one second word synonym;
automatically providing at least one synonym for the at least one synonym for the at least some of the other words that serve the second predetermined purpose;
thirdly comparing the at least one synonym for the at least one second word synonym with the at least one synonym for the at least one synonym for the at least some of the other words that serve the second predetermined purpose.

17. A method comprising:
providing a plurality of document groups, wherein each of the document groups includes at least one preexisting textual document;
providing a first textual document;
extracting at least one word from the first textual document pursuant to a first word selection criteria to provide at least a first extracted word;
using the first word selection criteria to extract words from the preexisting textual documents that comprise the document groups to provide candidate words;
comparing the first extracted word with the candidate words,
when the first extracted word matches at least one of the candidate words within a predetermined tolerance:
determining a normalized correspondence value for each of the document groups that includes at least one preexisting textual document that contains a candidate word that matches the first extracted word within the predetermined tolerance by relating a total number of preexisting textual documents that contain such a candidate word in each given document group with a total number of preexisting textual documents in each given document group.

18. The method of claim 17 wherein extracting at least one word from the first textual document pursuant to a first word selection criteria includes extracting at least one word from the first textual document pursuant to a first word selection criteria comprising at least a first grammatical purpose.

19. The method of claim 17 wherein extracting at least one word from the first textual document pursuant to a first word selection criteria includes extracting at least one word from the first textual document pursuant to a first word selection criteria comprising at least a first contextual purpose.

20. The method of claim 17 wherein relating a total number of preexisting textual documents that contain such a candidate word in each given document group with a total number of preexisting textual documents in each given document group includes dividing the total number of preexisting textual documents that contain such a candidate word in each given document group by the total number of preexisting textual documents in each given document group.

21. The method of claim 17 and further comprising, when the first extracted word does not match at least one of the candidate words within a predetermined tolerance:
providing at least one first extracted word synonym;
providing at least one candidate word synonym;
comparing the at least one first extracted word synonym with the at least one candidate word synonym;
when the at least one first extracted word synonym matches at least one of the at least one candidate word synonym within a predetermined tolerance:
determining a normalized correspondence value for each of the document groups that includes at least one preexisting textual document that contains a candidate word that corresponds to the candidate word synonym that matches the first extracted word synonym within the predetermined tolerance by relating a total number of preexisting textual documents that contain such a candidate word in each given document group with a total number of preexisting textual documents in each given document group.

22. A method comprising:
providing a body of text;
determining at least one category of speech;
identifying at least one instance of the at least one category of speech in the body of text to provide identifying text;
identifying, for each of a plurality of document groups that each include at least one textual document, those textual documents that are within a first predetermined semantic distance of the body of text as a function of the identifying text;
when there are no textual documents that are within the first predetermined semantic distance of the body of text, identifying each textual document that is within a second predetermined semantic distance of the body of text as a function of at least a first expression that comprises a synonym of the identifying text.

23. The method of claim 22 and further comprising:
when there are no textual documents that are within the second predetermined semantic distance of the body of text, identifying each textual document that is within a third predetermined semantic distance of the body of text as a function of at least a second expression that comprises a synonym of the first expression.

24. The method of claim 23 and further comprising:
when there are no textual documents that are within the third predetermined semantic distance of the body of text, identifying each textual document that is within a fourth predetermined semantic distance of the body of text as a function of at least a third express that comprises a synonym of the second expression.

25. A method for characterizing a document comprising a body of text with respect to at least one document group, which at least one document group is comprised of at least one text-containing document, comprising:
parsing the body of text and identifying at least one word that serves a predetermined purpose;
determining a semantic distance between the document and each of the at least one document groups as a function, at least in part, of:
firstly comparing the at least one word with other words that serve the predetermined purpose in the at least one document group;
when the at least one word does not match any of the other words within a predetermined tolerance:
automatically providing at least one synonym for at least one of:
the at least one word; and
at least some of the other words; and:
when providing at least one synonym for only the at least one word, comparing the at least one synonym with the other words;
when providing at least one synonym for at least some of the other words only, comparing the at least one synonym with the at least one word; and
when providing at least one synonym for both the at least one word and at least some of the other words, comparing the at least one synonym for the at least one word with the at least one synonym for at least some of the other words;
characterizing the document as a function, at least in part, of the semantic distance between the document and each of the at least one document groups.
